(19) United States
(12) Patent Application Publication
(10) Pub. No.: US 2010/0228611 A1
(43) Pub. Date: Sep. 9, 2010

(54) SYSTEM AND METHOD FOR ASSOCIATING CONTENT AND ADVERTISEMENT

(75) Inventor: Michael SHENFIELD, Mississauga (CA)

Correspondence Address: MOFFAT-RIM, 427 Laurier Avenue W., Suite 1200, Ottawa, ON, K1R 7Y2, CA

(73) Assignee: RESEARCH IN MOTION LIMITED, Waterloo (CA)

(21) Appl. No.: 12/399,204

(22) Filed: Mar. 6, 2009

(51) Int. Cl. G06Q 30/00; G06Q 90/00; G06F 17/00

(52) U.S. Cl. 705/14.4; 715/234

(57) ABSTRACT

A method and system for associating content and advertisement at a delivery client on a device, the method receiving a first data set having a metadata link associated therewith, the metadata link implies retrieval of a second data set; retrieving the second data set from a location defined by the metadata link; providing content to a first application, the content being one of the first data set and the second data set; and providing an advertisement to the first application or to a second application, the advertisement being the other one of the first data set and the second data set.

### FIELD OF THE DISCLOSURE

The present disclosure relates to content and advertisement delivery, and in particular to content and advertisement delivery utilizing metadata.

### BACKGROUND

Dynamic content delivery allows the passing of content to an application seeking the content, either through a pull or pushed based model. Content metadata is associated with the content and enables the proper delivery and handling of that content. Content metadata could include information about how to handle the content, when the content will expire, the application the content relates to, among other information.

Content metadata can have various attributes associated therewith. For example, the Open Mobile Alliance (OMA) dynamic content delivery (DCD) specification introduces various attributes for the content metadata, one of which is the “aux-content-link” attribute. The aux-content-link attribute provides a content identifier or link to additional content that is related to the content item or items being delivered. The intent of the attribute is to support pre-fetching content or progressive fetching of content referred to by the main content item, and likely to be requested later.

The aux-content-link attribute was provided in the DCD specification to be used when the DCD enabler delivers content via progressive download. The DCD specification mandates that the attribute be used as follows. If the aux-content-link content metadata attribute is present, the DCD client must send a DCD-1 ContentUpdateRequest message to the DCD server at the indicated link; and for content items being delivered by a progressive download, the DCD server must set the aux-content-link metadata attribute to the universal resource indicator (URI) of the next download segment, if any. The metadata attribute could be specified by either content provider or service provider.

### BRIEF DESCRIPTION OF THE DRAWINGS

The present application will be better understood with reference to the drawings, in which:

FIG. 1 is a data flow diagram of a first embodiment of the present system and method;

FIG. 2 is a data flow diagram showing the embodiment of FIG. 1 in which a mobile advertising client is added;

FIG. 3 is a data flow diagram showing an alternative scenario for the present system and method;

FIG. 4 is a data flow diagram showing the embodiment of FIG. 3 in which a mobile advertising client is added;

FIG. 5 is a block diagram showing an exemplary metadata envelope that could be used with the present disclosure;

FIG. 6 is a block diagram showing an exemplary metadata envelope with a processing document as part of a metadata link; and

FIG. 7 is a block diagram showing an exemplary mobile device that can be used with the method and system of the present disclosure.

### DETAILED DESCRIPTION

The present disclosure provides a method for associating content and advertisement at a delivery client on a device, the method comprising: receiving a first data set having a metadata link associated therewith, the metadata link implies retrieval of a second data set; retrieving the second data set from a location defined by the metadata link; providing content to a first application, the content being one of the first data set and the second data set; and providing an advertisement to the first application or to a second application, the advertisement being the other one of the first data set and the second data set.

The present disclosure further provides a device including a delivery client for associating content and advertisement, device comprising: a communications subsystem; an application configured to consume content and advertisement; the delivery client configured to: receive a first data set over the communications subsystem, the first data set including a metadata link associated therewith that implies retrieval of a second data set; retrieve the second data set from a location defined by the metadata link; provide content to a first application, the content being one of the first data set and the second data set; and provide the advertisement to the first application or a second application, the advertisement being the other one of the first data set and the second data set.

The present disclosure utilizes the OMA DCD attribute “aux-content-link” to obtain additional content or advertising, as described below. The present disclosure is however not limited to the OMA DCD specification, nor to the specific attribute “aux-content-link”. In other delivery architectures, other attributes may provide links to obtain additional content, and the use of the OMA DCD terminology below is merely exemplary.

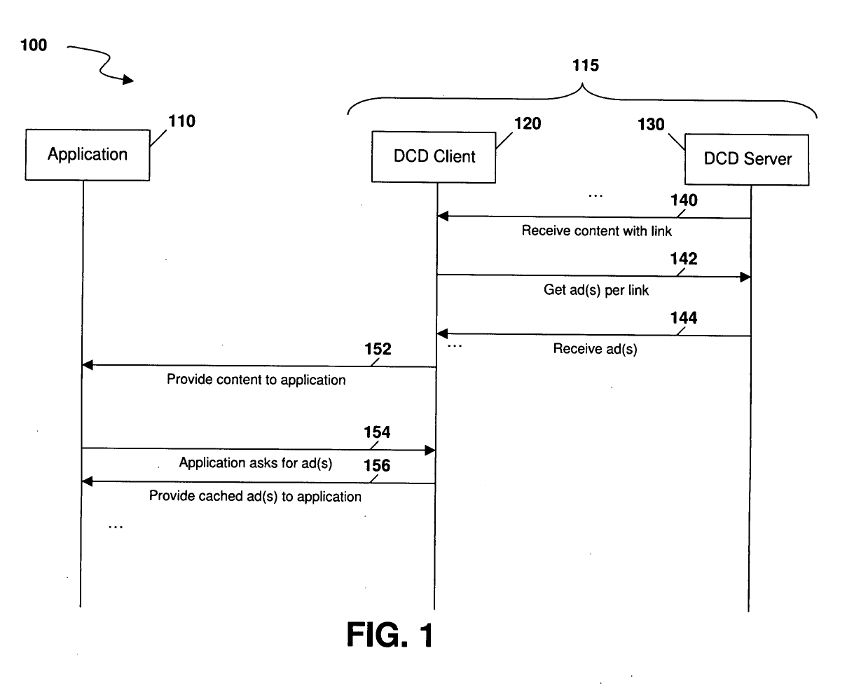

Reference is now made to FIG. 1.

A dynamic content delivery architecture 100 includes, in part, an application 110 and a dynamic content delivery enabler 115 with a DCD client 120 and DCD Server 130. The architecture 100 further includes at least one content provider (not shown) communicating with the DCD server 130 to provide content requested by the application 110. The content provider could also be an advertisement provider. Further, a proxy (not shown) may include DCD server 130, or DCD server 130 could be part of a network element.

Application 110, as used herein, is an application that consumes both content and advertisements. Application 110 can be, for example, a browser, a media player for playing video and/or audio files, a stock application, a weather application, among others. The present disclosure is not meant to be limited to any specific application 110 and those skilled in the art will realize that other applications than those listed exist.

Application 110 communicates with a dynamic content delivery enabler 115, which includes DCD client 120. DCD client 120 may be a client on a mobile device or a computer which permits an application 110 to register with it and further provides for communication over a network with a dynamic content delivery server 130.

In the dynamic content delivery environment, the dynamic content delivery client 120 communicates with a dynamic content delivery server 130 and provides subscriptions for various content. DCD server 130 could register with various content providers (not shown) and either request data (pull) from the content provider or receive published data (push) from the content provider.

The process of FIG. 1 is shown to include the reception of a message 140 from DCD server 130 by DCD client 120, the message 140 having a data set, the data set being content for application 110, and further including a link within the metadata.

The link, in one embodiment, is the aux-content-link attribute according to the OMA DCD specification.

The reception of message 140 by DCD client 120 could be based on a solicited message or could be unsolicited. Thus, DCD client 120 may have provided a request to DCD server 130 prior to receiving message 140. Alternatively, message 140 could be unsolicited based on a push from DCD server 130 to DCD client 120 when certain content becomes available. For example, DCD client 120 may have registered with DCD server 130 to receive certain types of content and, when the content becomes available, DCD server 130 may push the content to DCD client 120.

Responsive to message 140, the DCD client 120 processes the content and recognizes the aux-content-link attribute in the metadata for the content. Based on recognition of the aux-content-link attribute in the content, a message 142 is sent from DCD client 120 to the DCD server 130. In the case of FIG. 1, the link refers to an advertisement. For example, a device such as a mobile device or computer has subscribed to receive content but has also opted to receive advertisements in order to reduce or offset the price of the content received. In this case, the content received in message 140 could include a link to advertisements in the aux-content-link attribute and message 142 is used to retrieve the further data set, being the advertisement according to the link.

In one embodiment, message 142 is sent to DCD server 130 requesting the content associated with the aux-content-link. In other embodiments, message 142 could be sent directly to an advertisement provider, rather than sending a message through DCD server 130. For example, the aux-content-link attribute could specify an address or uniform resource identifier (URI) for the advertisement provider and/or an advertisement resource stored thereby.

Message 144 is returned in response to message 142. In message 144, the advertisement that is provided in the link of message 140 is provided to the dynamic content delivery client 120.

In some embodiments the use of the auxiliary content link may be beneficial when compared to merely providing the advertisement as part of the content of message 140. The use of the link reduces the size of message 140 that is passed to the DCD client 120. This may be important when push bearers are used. For example, push bearers may have a maximum size of data that can be pushed to the DCD client 120. By using an attribute such that the DCD client 120 retrieves the advertisement in a separate or distinct message (e.g., message 144), space can be retained for the content portion of message 140.

Further, the use of the aux-content-link attribute allows the advertisement to be preloaded onto a device such as a mobile device or computer. In this way, the user of the device may receive and view the advertisement when the content is consumed on the device. Specifically, the content that is pushed to the device or received by the device may not be consumed for a period of time. If using a mobile device, the user may be in an out of coverage situation when consuming the content, where the advertisement cannot be retrieved. This may degrade the user experience by requiring the user to wait for the retrieval of an advertisement.

Furthermore, preloading the advertisement may reduce delays during the consumption of the content. If an application is configured to load an advertisement during (i.e., substantially simultaneously with) content consumption, network conditions may cause delays that result in poor performance of the application.

Referring again to FIG. 1, when application 110 needs or is otherwise ready to present the content, DCD client 120 provides the content to the application. This is shown by message 152. Message 152, as will be appreciated by those skilled in the art, could be a solicited response to a request by application 110 for the content. Alternatively, message 152 could be communicated from DCD client 120 to application 110 in an unsolicited manner such that message 152 is pushed by DCD client 120 to application 110.

Application 110 receives the content from message 152 and processes the content. Part of the content includes the indication that an advertisement is associated with the received content. In response to receipt of message 152 the application 110 communicates in message 154 to DCD client 120 requesting the advertisement(s). The application asks for the advertisement by a link. The link is, in one embodiment, the same as the aux-content-link attribute. Thus, the link could be, for example, a universal resource locator (URL) or other identifier such as a URI.

DCD client 120 in response to receiving message 154, provides the cached advertisement to the application or to a second application configured to process the advertisement in message 156. Since the advertisement is cached the user does not need to wait for the advertisement and the advertisement is still displayed even if a mobile device is in an out of coverage situation.

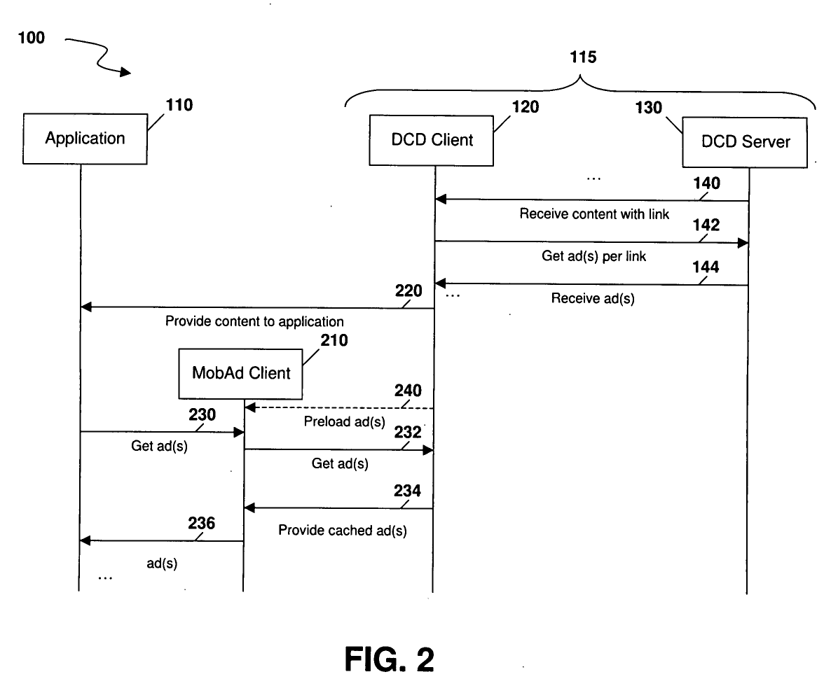

Reference is now made to FIG. 2. In some advertisement scenarios, a mobile advertising (MobAd) client is configured between an application 110 and DCD Client 120 to provide advertisements. FIG. 2 shows the data flow of FIG. 1 with the exception that a mobile advertising client 210 is added. In this case, application 110 knows that in order to receive advertisements, the application 110 needs to communicate with mobile advertising client 210 in cooperation with DCD client 120.

The example of FIG. 2 starts the reception of message 140 by DCD client 120, message 140 containing a content data set. Again, message 140 could be solicited or unsolicited as described previously.

In response to receiving message 140, DCD client 120 sends message 142 to retrieve the data associated with the metadata link attribute. In this case, an advertisement is provided in the link and DCD client 120 requests the advertisement either from DCD server 130 or directly from an advertising provider (not shown) in message 142.

Responsive to message 142, DCD server 130 (or an advertisement provider) responds by communicating the further data set in message 144, the further data set being an advertisement.

DCD client 120 then provides the content to application 110 in message 220. Message 220 only provides the content to the application and could be solicited based on a request from the application to DCD client 120 for content, or could be unsolicited and based on a push scenario from DCD client 120 to application 110.

Application 110, when processing the content received in message 220 recognizes or otherwise determines that an advertisement is associated with the received content and the application 110 sends a message 230 to advertising client 210 to get an advertisement. The advertisement is referenced by URL or ID and the reference to the advertisement, in one embodiment, matches the method of identifying the advertisement in an aux-content-link attribute.

Mobile advertising client 210 can then send message 232 to DCD client 120 in order to get the advertisement(s) requested by message 230. In response to message 232, DCD client returns message 234 providing the cached advertisement or advertisements. These advertisements are then returned to the application 110 utilizing the message 236.

Alternatively, mobile advertising client 210 can be preloaded with the advertisement(s), for example at an instant of time that is substantially simultaneous with or otherwise corresponding to reception of ad(s) (i.e., message 144) at the DCD client 120. This is shown by the dotted line 240, which indicates that advertisements may be provided in advance to advertising client 210. In the case where advertisements are preloaded at mobile advertising client 210, messages 232 and 234 may not be communicated.

FIGS. 1 and 2 therefore provide for the link within metadata that allows a content item to be associated with advertisements when the content is delivered. The DCD client 120 receives a link such as a URL of the associated advertisements when it processes the received content items. It retrieves and caches the advertisement for future delivery to a device application that consumes the content items or to another application dedicated to mobile advertisement. Such advertisement could be specified in an aux-content-link by URL, which could point to an advertiser, service provider or content provider domain or by any identifier such as a universal resource identifier (URI) recognizable by the DCD server 130.

An example of a message 140 from FIGS. 1 and 2 above could be:

Example 1 (content packaged with DCD envelope format):

```
    <client-package>
      <dc-cnt-metadata content-id=“0xB12F” content-price=“0.02”
          aux-content-link=“http://advendor.com/xyz_corp/finance/
          ad123.dat”/>
      <content>
        “XYZ Stores on Tuesday reported a jump in earnings during its
key holiday quarter, topping analysts' estimates. Shares of XYZ
Corporation jumped nearly 3 percent”
        </content>
      <client-package>
```

Example 2 (content packaged in RSS feed with DCD metadata embedded in the feed):

```
<rss version=“2.0” xmlns:dcd=“http://www.openmobilealliance.com/
oma-dcd/1.0>
  <dc-cnt-metadata content-id=“0xB12F” content-price=“0.02”
          aux-content-link=“http://advendor.com/xyz_corp/finance/
          ad123.dat”/>
    <channel>
      <title>Top business stories</title>
      <link>http://www.qrs.com/bus/rss</link>
      <description> Top business stories</description>
      <item>
          <title>XYZ Corporation reports jump in profit</title>
            <link>http://abc.com/click/here.pl?80da344efa6a</link>
            <pubDate>Sat, 10 Jan 2009 12:07:31 GMT</pubDate>
            <description>XYZ Stores on Tuesday reported a jump in
earnings during its key holiday quarter, topping analysts' estimates. Shares
of XYZ Corporation jumped nearly 3 percent
          </description>
          <guid>http://abc.com/id?80da344efa6a</guid>
      </item>
      <image>
            <url>http://qrs.com.au/top/img/xyzcorp.gif</url>
            <title>XYZ Corporation beats estimates</title>
            <link>http://www.qrs.com/bus/rss</link>
            <width>142</width>
            <height>40</height>
      </image>
    </channel>
</rss>
```

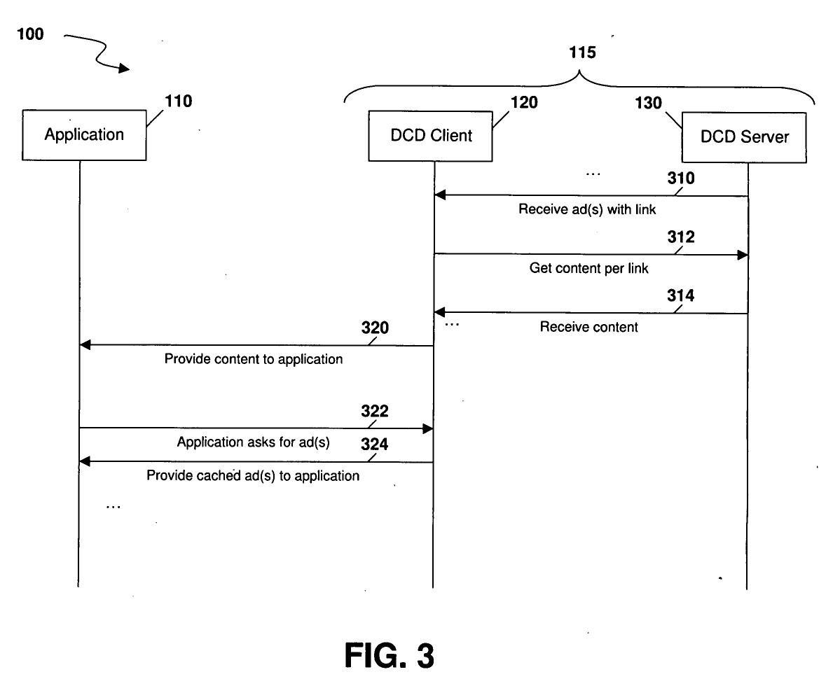

Reference is now made to FIG. 3. FIG. 3 illustrates an alternative embodiment for delivering content. In FIG. 3, application 110 communicates with DCD enabler 115, which may include DCD client 120 communicating, cooperating or otherwise associated with DCD server 130.

Instead of providing content with an aux-content-link to an advertisement, the embodiment of FIG. 3 provides a data set containing an advertisement in message 310 with an aux-content-link attribute pointing to a further data set containing associated content. That is, in comparison with FIG. 1, the content is referenced by the aux-content-link attribute instead of the advertisement.

Message 310 can either be either solicited or unsolicited. In other words, DCD client 120 could have requested content from DCD server 130 in which case the message 310 is solicited and is a pull response.

Alternatively, the message 310 could be unsolicited and result from a push of content from DCD server 130 to DCD client 120.

In response to receiving message 310, DCD client 120 sends message 312 to DCD server 130. Message 312 communicated from DCD client 120 to the DCD server 130 to request and obtain the content specified in the aux-content-link attribute.

In response to message 312, DCD server 130 sends message 314, containing the requested content, back to DCD client 120.

Alternatively, instead of sending message 312 and 314 from DCD client 120 and DCD server 130 respectively, the aux-content-link could have a link to a source for the content that is outside of the DCD server. In this case, message 312 would directly link to the provider of the content and message 314 would be a response from the provider of the content.

Once DCD client 120 has received the content and the advertisement according to messages 314 and 310 respectively, DCD client 120 then provides the content to application 110 in message 320. Message 320 can again, as described previously, be either solicited or unsolicited. If the message 320 is solicited, it is communicated as a result of a request (not shown) from application 110 to DCD client 120. If message 320 is unsolicited then it is a push from the DCD client 120 to application 110.

Application 110 processes the content received in message 320 and recognizes or otherwise determines that advertisements are required. Application 110 then sends a message 322 to DCD client 120 to receive the advertisement.

In one embodiment, message 322 specifies the desired advertisement(s) by a reference such as a content identifier. This is done since message 310 contained a content identifier rather than an advertising identifier, as in the embodiment of FIG. 1.

In response to message 322, DCD client 120 responds with message 324 to application 110. Alternatively, a second application may receive the advertisement and process it. Message 324 provides the advertisement that is cached by DCD client 120.

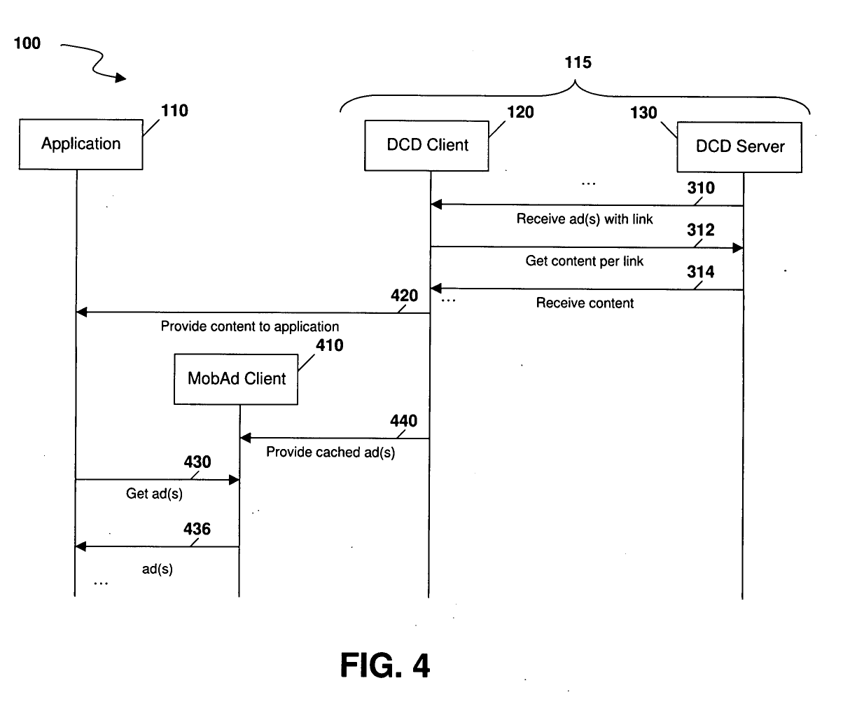

Reference is now made to FIG. 4. FIG. 4 is an alternative embodiment to FIG. 3 in which a mobile advertising (MobAd) client 410 is provided. Application 110 still communicates with DCD client 120 and DCD client 120 communicates with DCD server 130.

DCD client 120 receives a message 310 which provides an advertisement with an aux-content-link attribute in the metadata pointing to content for DCD client 120, and ultimately for application 110. Message 310 can be solicited or unsolicited, as described previously.

In response to message 310, DCD client 120 sends message 312 to DCD server 130 or other source of content to retrieve the content and a response 314 containing the content is received back at DCD client 120.

DCD client 120 then provides the content to application 110 in message 420. Message 420 can be communicated in a solicited or unsolicited manner. Specifically, application 110 can request content or, for example, be registered or subscribed with DCD client 120 to have content pushed to it.

When consuming the content received in message 420, application 110 recognizes or otherwise determines that it needs to retrieve the advertisement and in response it sends a request 430 to mobile advertising client 410 to request the advertisements and receives a response 436 with the advertisement from the mobile advertising client 410.

Mobile advertising client 410 can request the advertisements from DCD client 120 as described above with reference to FIG. 2. Alternatively, as shown in FIG. 4, the DCD client 120 could provide the advertisements to mobile advertising client 410, as shown by message 440, prior to advertisements being requested by application 110.

FIG. 3 and 4 therefore use a different approach for linking of the advertisement with content using the aux-content-link metadata attribute. The attribute in this case is used as a link to associated content while delivering the advertising content using the DCD enabler 115, and specifically the DCD client 120 and server 130.

In the embodiments of FIG. 3 and 4, the aux-content-link attribute located in the content metadata and associated with advertisement content contains a reference which could be a URL identifier such as URI or content identifier to the content to which the advertisement is related.

An example of a message 310 from FIGS. 3 and 4 above could be:

```
    <client-package>
      <dc-cnt-metadata content-id=“0xB12F” mime-type=”image/gif” content-type=“advertisement”
          aux-content-link=“http://qrsnews.com/top-strories/finance/video/xyzcorp.mpeg”/>
      <content>
  “data:image/gif;base64,R0lGODdhMAAwAPAZAwAAAC8IyPqcvt3wCcDkiLc7C0qwyGHhS
pjQu5yqmCYsapyuvUUlvONmOZtfzgFzfagowXhGargtWNO7PsFk90xQpqPTOrNTZ0Ux9xdvIjLpwz3”
        </content>
    <client-package>
```

As will be appreciated, the previously-described embodiments are not configured such that the reception of the advertisement drives the consumption of the associated content. Rather, the present disclosure provides an advantage that the limited size of the advertisement can initially be communicated over push bearers with the retrieval of the larger size content being done over dedicated pull bearers. In the example message 310 above, the content is video and could potentially be large. The use of the link allows pull bearers to be used. For example, subsequent retrieval could utilize hypertext transfer protocol (HTTP).

From a target application's perspective, both the content and advertisement appear to be pushed since the retrieval of the content is automatic based on the aux-content-link attribute.

In a further embodiment, a further service or enabler which uses a dynamic content delivery enabler 115 from FIGS. 1 to 4 or that is associated with the use of dynamic content delivery may provide extensible markup language (XML) schema extensions for dynamic content delivery metadata attributes that define how to parse and process the dynamic content delivery metadata attributes in the context of another enabler.

In particular, in one embodiment, the content of the aux-content-link attribute may contain an XML document that encapsulates an XML element or attribute with reference to the associated advertisement plus some XML additional elements or attributes. In other words, additional processing may be provided for the aux-content-link attributes. The addition elements may include, for example, a target application to which the advertisement should be passed; a processing model or action such as “display upon retrieval”, “cache until requested” among others; a retrieval mode such as “immediate”, “with a delay” such as when content is consumed or by a schedule such as retrieving once a day or a predefined date or time or based on periodic intervals; any additional metadata such as expiration date or time, an encrypted identifier for the add within the content or a non-public identifier, among others. The list of the additional XML elements is not exhaustive and other additional XML elements may be added.

In one embodiment, an XML name space declaration can be made to allow the processing of the additional elements or attributes for the XML. Thus, XML elements related to non-dynamic content delivery grammar can be scoped to a declared or predefined name space. A DCD client 120 could then use the name space declaration to locate appropriate schema and to parse the aux-content-link attribute.

An exemplary XML fragment is provided below:

```
  ...xmlns:ad=”http://oma.org/mobad/1.0”...
  ...
  <client-package>
      <dc-cnt-metadata content-id=“0xB12F” content-price=“0.02”
            aux-content-link=“<ad:process target=‘adclient’ type=
’interstitial’ action=’display-before’/><ad:source url=’,
http://advendor.com/xyzcorp/finance/ad123.dat’>”/>
      <content>
        “XYZ Stores on Tuesday reported a jump in earnings during its
key holiday quarter, topping analysts' estimates. Shares of XYZ
Corporation jumped nearly 3 percent”
      </content>
  <client-package>
```

This alternative embodiment therefore allows for the extension of the XML attribute to provide for processing intelligence with regard to the link to either the advertisement, as described above with reference to FIGS. 1 and 2, or with regard to the content as described above with reference to FIGS. 3 and 4.

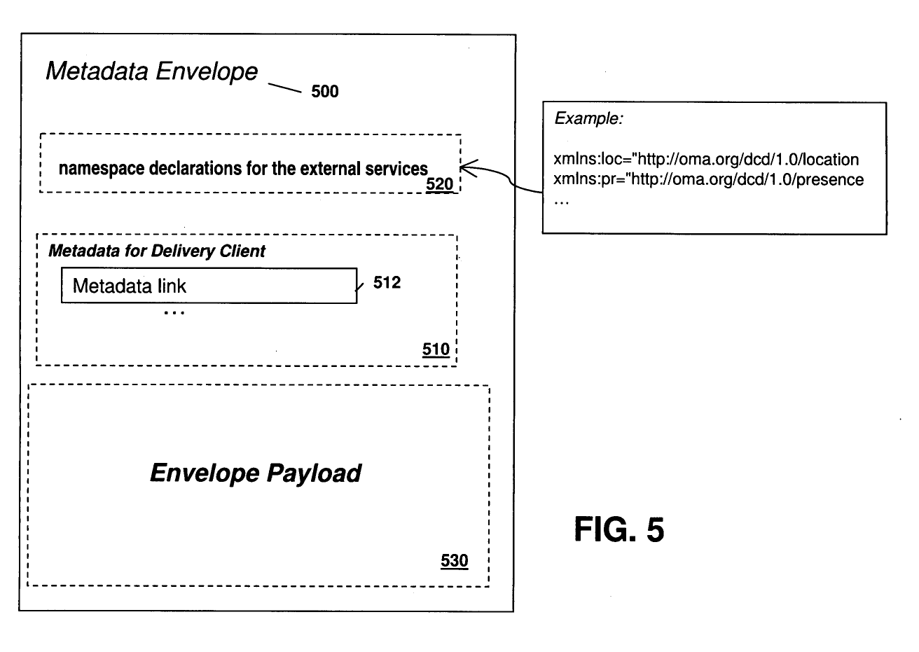

Reference is now made to FIG. 5, which illustrates an exemplary metadata envelope that may be used for providing content and metadata to delivery client 120. The envelope model illustrated in FIG. 5 is provided as an example and other means for conveying metadata, such as RSS and ATOM feeds with embedded metadata and content would be apparent to those skilled in the art having regard to the present disclosure.

FIG. 5, metadata envelope 500 is destined for delivery client 120. In this regard, metadata envelope 500 includes a metadata portion 510 for the delivery client 120. This metadata portion 510 includes the aux-content-link 512, which in the embodiment of FIG. 1 or 2 would include a link to advertising content, or in the embodiment FIG. 3 or 4 a link to the content.

A namespace declaration 520 could be utilised by the content provider or delivery server to allow XML schema to be utilised as part of the metadata for the delivery client 510.

Further, envelope payload 530 is provided in metadata envelope 500. Such envelope payload 530 could include the content that application 110 requested or could include advertisements in the embodiments of FIGS. 3 and 4.

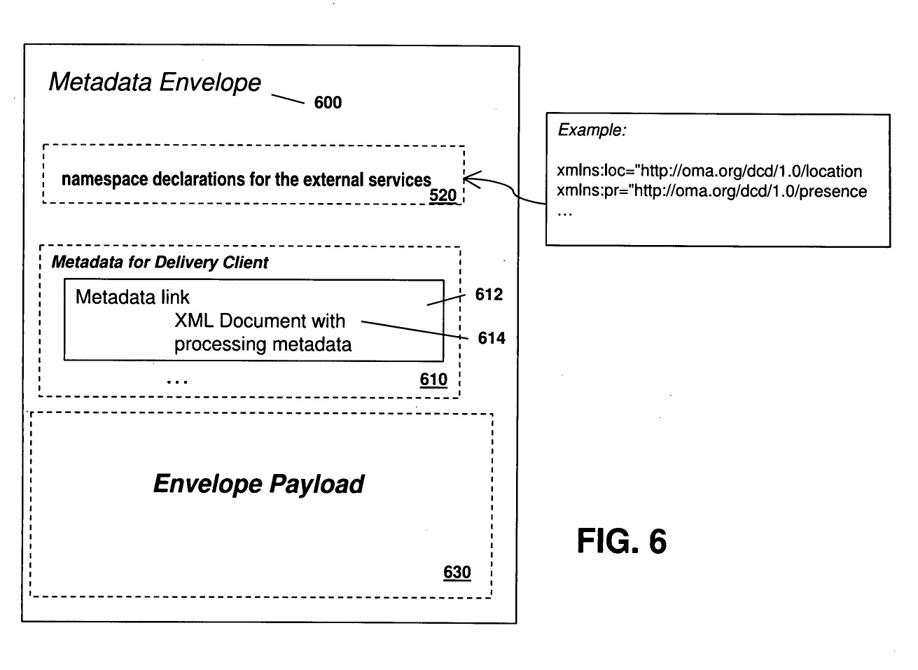

The above can be extended to provide processing information. In this regard reference is made to FIG. 6. In FIG. 6 metadata envelope 600 includes metadata for delivery client 610. An aux-content-link 612 further includes processing metadata 614.

The processing metadata 614 can utilise a namespace declaration 620 to extend XML schema.

Further, envelope payload 630 is provided in metadata envelope 600.

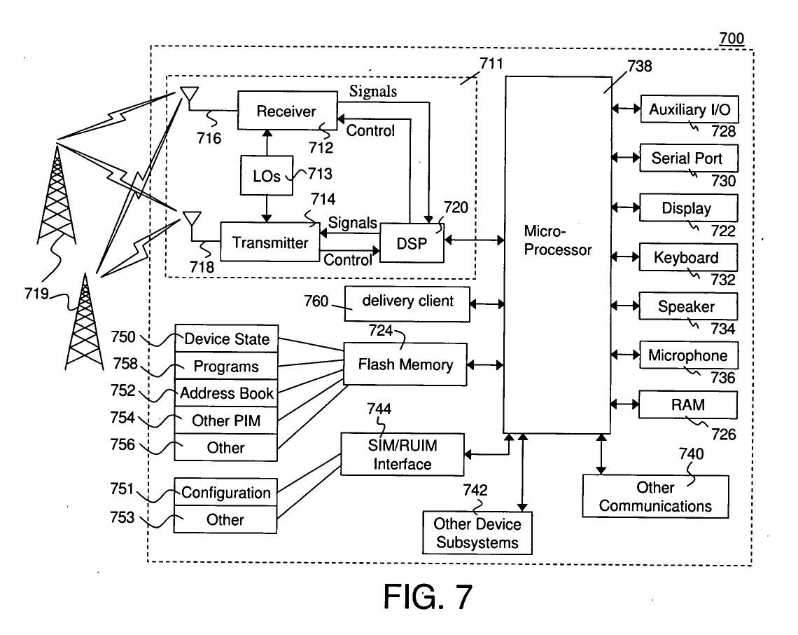

The delivery client and application can be configured on any device, both wired and wireless. If implemented on a mobile device, one particular mobile device that is illustrated as an example is provided in FIG. 7. Reference is now made to FIG. 7.

FIG. 7 is a block diagram illustrating a mobile device capable of being used with embodiments of the apparatus and method of the present application. Mobile device 700 is typically a two-way wireless communication device having voice and data communication capabilities. Mobile device 700 may have the capability to communicate with other computer systems on the Internet. Depending on the exact functionality provided, the wireless device may be referred to as a data messaging device, a two-way pager, a wireless e-mail device, a cellular telephone with data messaging capabilities, a wireless Internet appliance, or a data communication device, as examples.

Where mobile device 700 is enabled for two-way communication, it will incorporate a communication subsystem 711, including both a receiver 712 and a transmitter 714, as well as associated components such as one or more, embedded or internal, antenna elements 716 and 718, local oscillators (LOs) 713, and a processing module such as a digital signal processor (DSP) 720. As will be apparent to those skilled in the field of communications, the particular design of the communication subsystem 711 will be dependent upon the communication network in which the device is intended to operate.

Network access requirements will also vary depending upon the type of network 719. In some CDMA networks network access is associated with a subscriber or user of mobile device 700. A CDMA mobile device may require a removable user identity module (RUIM) or a subscriber identity module (SIM) card in order to operate on a CDMA network. The SIM/RUIM interface 744 is normally similar to a card-slot into which a SIM/RUIM card can be inserted and ejected like a diskette or PCMCIA card. The SIM/RUIM card can have approximately 64K of memory and hold many key configuration 751, and other information 753 such as identification, and subscriber related information.

When required network registration or activation procedures have been completed, mobile device 700 may send and receive communication signals over the network 719. As illustrated in FIG. 7, network 719 can consist of multiple base stations communicating with the mobile device. For example, in a hybrid CDMA 1×EVDO system, a CDMA base station and an EVDO base station communicate with the mobile device and the mobile device is connected to both simultaneously. The EVDO and CDMA 1× base stations use different paging slots to communicate with the mobile device.

Signals received by antenna 716 through communication network 719 are input to receiver 712, which may perform such common receiver functions as signal amplification, frequency down conversion, filtering, channel selection and the like, and in the example system shown in FIG. 7, analog to digital (A/D) conversion. A/D conversion of a received signal allows more complex communication functions such as demodulation and decoding to be performed in the DSP 720. In a similar manner, signals to be transmitted are processed, including modulation and encoding for example, by DSP 720 and input to transmitter 714 for digital to analog conversion, frequency up conversion, filtering, amplification and transmission over the communication network 719 via antenna 718. DSP 720 not only processes communication signals, but also provides for receiver and transmitter control. For example, the gains applied to communication signals in receiver 712 and transmitter 714 may be adaptively controlled through automatic gain control algorithms implemented in DSP 720.

Mobile device 700 generally includes a microprocessor 738 which controls the overall operation of the device. Communication functions, including at least data and voice communications, are performed through communication subsystem 711. Microprocessor 738 also interacts with further device subsystems such as the display 722, flash memory 724, random access memory (RAM) 726, auxiliary input/output (I/O) subsystems 728, serial port 730, one or more keyboards or keypads 732, speaker 734, microphone 736, other communication subsystem 740 such as a short-range communications subsystem and any other device subsystems generally designated as 742. Serial port 730 could include a USB port or other port known to those in the art.

Some of the subsystems shown in FIG. 7 perform communication-related functions, whereas other subsystems may provide “resident” or on-device functions. Notably, some subsystems, such as keyboard 732 and display 722, for example, may be used for both communication-related functions, such as entering a text message for transmission over a communication network, and device-resident functions such as a calculator or task list.

Operating system software used by the microprocessor 738 is preferably stored in a persistent store such as flash memory 724, which may instead be a read-only memory (ROM) or similar storage element (not shown). Those skilled in the art will appreciate that the operating system, specific device applications, or parts thereof, may be temporarily loaded into a volatile memory such as RAM 726. Received communication signals may also be stored in RAM 726.

As shown, flash memory 724 can be segregated into different areas for both computer programs 758 and program data storage 750, 752, 754 and 756. These different storage types indicate that each program can allocate a portion of flash memory 724 for their own data storage requirements. Microprocessor 738, in addition to its operating system functions, preferably enables execution of software applications on the mobile device. A predetermined set of applications that control basic operations, including at least data and voice communication applications for example, will normally be installed on mobile device 700 during manufacturing. Other applications could be installed subsequently or dynamically.

One software application may be a personal information manager (PIM) application having the ability to organize and manage data items relating to the user of the mobile device such as, but not limited to, e-mail, calendar events, voice mails, appointments, and task items. Naturally, one or more memory stores would be available on the mobile device to facilitate storage of PIM data items. Such PIM application would preferably have the ability to send and receive data items, via the wireless network 719. In one embodiment, the PIM data items are seamlessly integrated, synchronized and updated, via the wireless network 719, with the mobile device user's corresponding data items stored or associated with a host computer system. Further applications may also be loaded onto the mobile device 700 through the network 719, an auxiliary I/O subsystem 728, serial port 730, short-range communications subsystem 740 or any other suitable subsystem 742, and installed by a user in the RAM 726 or preferably a non-volatile store (not shown) for execution by the microprocessor 738. Such flexibility in application installation increases the functionality of the device and may provide enhanced on-device functions, communication-related functions, or both. For example, secure communication applications may enable electronic commerce functions and other such financial transactions to be performed using the mobile device 700.

In a data communication mode, a received signal such as a text message or web page download will be processed by the communication subsystem 711 and input to the microprocessor 738, which preferably further processes the received signal for output to the display 722, or alternatively to an auxiliary I/O device 728. A delivery client 760, which could be equivalent to delivery client 120 could also process the input.

A user of mobile device 700 may also compose data items such as email messages for example, using the keyboard 732, which is preferably a complete alphanumeric keyboard or telephone-type keypad, in conjunction with the display 722 and possibly an auxiliary I/O device 728. Such composed items may then be transmitted over a communication network through the communication subsystem 711.

For voice communications, overall operation of mobile device 700 is similar, except that received signals would preferably be output to a speaker 734 and signals for transmission would be generated by a microphone 736. Alternative voice or audio I/O subsystems, such as a voice message recording subsystem, may also be implemented on mobile device 700. Although voice or audio signal output is preferably accomplished primarily through the speaker 734, display 722 may also be used to provide an indication of the identity of a calling party, the duration of a voice call, or other voice call related information for example.

Serial port 730 in FIG. 7, would normally be implemented in a personal digital assistant (PDA)-type mobile device for which synchronization with a user's desktop computer (not shown) may be desirable, but is an optional device component. Such a port 730 would enable a user to set preferences through an external device or software application and would extend the capabilities of mobile device 700 by providing for information or software downloads to mobile device 700 other than through a wireless communication network. The alternate download path may for example be used to load an encryption key onto the device through a direct and thus reliable and trusted connection to thereby enable secure device communication. As will be appreciated by those skilled in the art, serial port 730 can further be used to connect the mobile device to a computer to act as a modem.

Other communications subsystems 740, such as a short-range communications subsystem, is a further optional component which may provide for communication between mobile device 700 and different systems or devices, which need not necessarily be similar devices. For example, the subsystem 740 may include an infrared device and associated circuits and components or a Bluetooth™ communication module to provide for communication with similarly enabled systems and devices.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

1. A method for associating content and advertisement at a delivery client on a device, the method comprising:
receiving a first data set having a metadata link associated therewith, the metadata link implies retrieval of a second data set;
retrieving the second data set from a location defined by the metadata link;
providing content to a first application, the content being one of the first data set and the second data set; and
providing an advertisement to the first application or to a second application, the advertisement being the other one of the first data set and the second data set.

2. The method of claim 1 wherein the receiving is performed over a push bearer.

3. The method of claim 1 wherein the receiving is performed based on a request for the first data set.

4. The method of claim 1 wherein the link is an aux-content-link attribute in Content Metadata as specified in Open Mobile Alliance dynamic content delivery enabler.

5. The method of claim 1 wherein the retrieving the second data set utilises a delivery server.

6. The method of claim 1 wherein the providing the advertisement utilises a mobile advertising client between the application and delivery client.

7. The method of claim 1 wherein the device is a mobile device.

8. The method of claim 1 wherein the metadata link includes a document encapsulating an element or attribute for additional processing of the second data set.

9. The method of claim 8 wherein the document is an extensible markup language document.

10. The method of claim 1 wherein the providing the content and the providing the advertisement is performed by pushing the content and advertisement to the application.

11. A device including a delivery client for associating content and advertisement, device comprising:
a communications subsystem;
a first application; and
the delivery client configured to:
receive a first data set over the communications subsystem, the first data set including a metadata link associated therewith that implies retrieval of a second data set;
retrieve the second data set from a location defined by the metadata link;
provide content to the first application, the content being one of the first data set and the second data set; and
provide the advertisement to the first application or a second application, the advertisement being the other one of the first data set and the second data set.

12. The device of claim 11 wherein the receiving of the first data set is performed over a push bearer.

13. The device of claim 11 wherein the receiving of the first data set is performed based on a request for the first data set.

14. The device of claim 11 wherein the link is an aux-content-link attribute in an Open Mobile Alliance dynamic content delivery architecture.

15. The device of claim 11 further comprising a mobile advertising client between the application and delivery client for communicating one of the first data set and the second data set to one of the first application and the second application.

16. The device of claim 11 wherein the metadata link includes a document encapsulating an element or attribute for additional processing of the second data set.

17. The device of claim 16 wherein the document is an extensible markup language document.

18. The device of claim 11 wherein the delivery client is configured to push the content and advertisement to one of the first application and the second application.
